(19) United States
(12) Patent Application Publication
(10) Pub. No.: US 2017/0333823 A1
(43) Pub. Date: Nov. 23, 2017

(54) DEVICE FOR REDUCING THE NUMBER OF SOLID PARTICLES IN THE AMBIENT AIR

(71) Applicant: ebm-papst Mulfingen GmbH & Co. KG, Mulfingen (DE)

(72) Inventor: Michael ECCARIUS, Mulfingen (DE)

(21) Appl. No.: 15/479,381

(22) Filed: Apr. 5, 2017

(30) Foreign Application Priority Data
May 20, 2016 (DE) 10 2016 109 301.7

(51) Int. Cl. B01D 46/42; B01D 46/00

(52) U.S. Cl. CPC B01D 46/42; B01D 46/0057; B01D 46/0036; B01D 46/002; B01D 2279/30; B01D 2279/40

(57) ABSTRACT

The disclosure relates to an apparatus for reducing the quantity of solid particles in ambient air. A predefined treatment area is delimited at least in part by an enclosure. The enclosure is at least partially non-physical and formed by at least one air curtain that can be produced by an air flow generating device. At least one air filter device, which is connected in terms of flow to the ambient air of the treatment area is designed to filter solid particles directly out of the ambient air of the treatment area.

### CROSS-REFERENCE TO RELATED APPLICATIONS

This application claims the benefit and priority of German Patent Application No. 10 2016 109 301.7, filed May 20, 2016. The entire disclosure of the above application is incorporated herein by reference.

### FIELD

The invention relates to an apparatus for reducing the quantity of solid particles, in particular suspended particles, pollen and the like, from the ambient air of a predefined treatment area.

### BACKGROUND

Suspended particles may alternatively be referred to as total suspended particles, and are also known as TSP (total suspended particulates).

The disclosure can also be used for reducing the quantity of fine particulates, which lead to ever-increasing pollution levels, particularly in cities, and which are generated in part by vehicles (combustion, brake dust) and other combustion systems, and are in part stirred up by wind or by the movement of vehicles.

Particularly in areas where multiple particle-emitting sources are brought together or where traffic levels are high on multiple-lane roadways and intersections, the quantity of solid particles increases substantially and over time can lead to health problems.

Methods and apparatuses for reducing particle pollution are already known in the prior art. Such methods and apparatuses involve spraying a cleaning agent into the ambient air as an extraction agent, to which the suspended particles then bind. Aerosols in particular are used for this purpose. The concept underlying these methods and apparatuses involves cleaning the ambient air by means of the extraction agent. However, this requires that the extraction agent, together with the particles bound thereto, must be recollected, purified and disposed of. In addition, spraying apparatuses and collecting means are required. A further negative aspect of this type of solution is that the area into which the extraction agent is introduced also becomes saturated with particles of the extraction agent, and during the cleaning phase, the ambient air consists of a mixture of particulate matter and extraction agent. Furthermore, when a liquid extraction agent, for example water, is introduced into the area around roadways, static friction is reduced and the degree of vehicle soiling is increased.

### SUMMARY

It is therefore the object of the invention to provide a barrier-free apparatus for at least temporarily reducing the quantity of solid particles, in which the stated disadvantages are at least partially reduced.

According to the disclosure, an apparatus for reducing the quantity of solid particles in ambient air is proposed. The apparatus establishes a predefined treatment area, which is delimited at least in part by an enclosure. The enclosure is at least partially non-physical and formed by at least one air curtain that can be produced by an air flow generating device. The apparatus further comprises at least one air filter device, which is connected in terms of flow to the ambient air of the treatment area and which is designed to filter the solid particles out of the ambient air of the treatment area immediately, i.e. directly and without these first adhering to another medium.

The treatment area is predefined or established in particular in the area where the particle emission occurs, so that the treatment area initially has an elevated particle concentration that is to be reduced by means of the invention. The treatment area also provides a shielding effect, preventing the particles from spreading into areas outside of the treatment area. Thus by defining the treatment area in specific high-emission areas, such as multiple-lane road intersections in cities, surrounding areas are also protected, thereby increasing the efficacy of the apparatus of the invention, since the relative filter performance is greater where the air is more heavily contaminated with solid particles.

Filtering the solid particles directly out of the ambient air of the treatment area is more efficient than known methods that use an extraction agent, and does not harm the environment during the cleaning phase.

A further significant advantage of the solution according to the disclosure is the barrier-free design of the apparatus, achieved by the at least partially non-physical enclosure. In general, enclosing the treatment area is advantageous for isolating and thereby specifically filtering the ambient air within the treatment area. The partially non-physical enclosure created by generating an air curtain allows a barrier-free entry into the treatment area by walking or driving, since it is necessary only to penetrate the air curtain formed by an air flow. Moreover, the air curtain has no visual impact on the environment.

In one embodiment of the apparatus, however, it is provided that some zones of the enclosure are physical, i.e. formed, for example, by one or more walls, a roof and/or a frame structure. A physical boundary in the form of a wall or a roof increases the performance capacity of the apparatus and provides points for the attachment of at least one air flow generating device or for the air filter device.

In one embodiment example, a physical part of the enclosure is provided at least partially by an air-permeable element. Advantageous in particular is an embodiment in which the base surface of the treatment area is formed by a grate, as an air-permeable element. In that case, the base surface further comprises the driving surface of a road. A solution of this type offers the advantageous option of installing the air filter device immediately adjacent to the treatment area, producing a direct and cost-effective flow connection. Shafts that are covered by the grate can be installed in the base, and the air filter devices can then be positioned and supplied with power in these shafts. An arrangement of this type is also advantageous in terms of the cleaning efficacy of the apparatus, since the elimination of solid particles by filtration is carried out in the immediate vicinity of the emission sources and thus before the particles can be dispersed.

In an alternative variant, the air filter devices are arranged within the treatment area. With a solution of this type, the ambient air of the treatment area is suctioned in directly, cleaned of solid particles in the appropriate air filter device, and discharged into the treatment area or the area outside the treatment area.

In one advantageous embodiment, at least one fan is used as the air flow generating device. In this case, the fan can advantageously be adjusted with respect to its blowing distance and/or blowing pattern. To generate what is known in English as the “air curtain”, air curtain systems that have a wide cross-section are particularly suitable. Fans of this type are capable of producing an air barrier between the treatment area and the area outside of the treatment area that prevents any exchange of solid particles. In addition or as an alternative to using at least one fan as an air flow generating device, groups of fans of the same or different size and power may be used, preferably synchronized with one another.

For the air curtain, high flow rates are advantageous and are produced. For this purpose, the fans have a high output capacity. In contrast, the air filter device is designed to suction air in from the treatment area, and its intake capacity is lower than the output capacity of the fans. The resulting different flow rates of the air curtain and the intake system lead to stable air conditions, without undesirable turbulence in the region of the air curtain.

In a refinement of the disclosure, at least one air intake device is provided, which is designed to exert a suctioning effect on the air curtain. As a result, the air curtain is stabilized, so that, for example, vehicles driving through the curtain will not generate a significant air exchange with a region outside of the treatment area. Advantageous in this case is an embodiment in which the air intake device is arranged in the same plane as and opposite the air flow generating device, so that the air flow generated by the air flow generating device is suctioned up in the one plane by the air intake device. The air curtain can thus be generated in a single plane. Advantageously, the plane extends vertically.

In one embodiment of the device, the air filter device is integrated into the air intake device. The air curtain constantly carries solid particles along with it out of the treatment area and is suctioned in by the air intake device, where it is purified directly. Combining the air intake device with the air filter device reduces the number of components that are required and as a result, the cost. Fans that produce a suctioning effect may likewise be used as the air intake device.

In one variant, the air flow generating device or the fan comprises an ionization module, with which the discharged air can be ionized. This increases the tendency of the solid particles to adhere, so that the air that is suctioned in by the air intake device for filtering contains a relatively greater quantity of solid particles, thereby increasing the filter performance.

If multiple air filter devices are used, these can advantageously be positioned in variable locations on the enclosure. This can be achieved, for example, by using a system of rails to which the air filter devices are attached such that they can be moved to different positions.

As filters for the solid particles, mechanical filters that are known from the prior art may be used, which are replaced at regular intervals. Backwash filters may also be used, which function without the replacement of filter elements and which bind solid particles in a liquid. Further advantageous is an embodiment of the air filter device having a periodically self-cleaning filter, as is known, for example, with diesel particle filters.

Other advantageous refinements of the disclosure are specified in the dependent claims and will be described in greater detail in the following, together with the description of the preferred embodiment of the invention, in reference to the figures.

### DRAWINGS

The figures show, by way of example:

FIG. 1 a schematic diagram of the apparatus on a road,

FIG. 2 an alternative embodiment of the apparatus of FIG. 1.

### DESCRIPTION

The same reference signs are used to denote the same parts or elements in all views. The figures are intended solely to provide a better understanding of the invention.

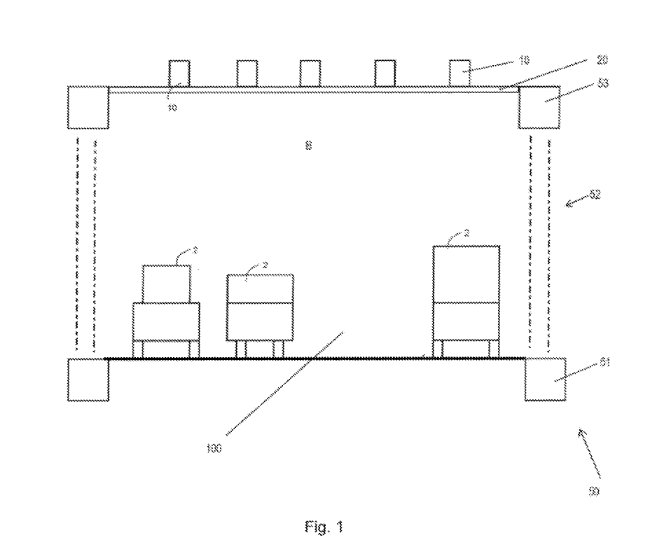

FIG. 1 shows a schematic diagram, by way of example, of an apparatus 50 for reducing the quantity of solid particles in the ambient air of the predefined treatment area B. Treatment area B delimits, by means of an enclosure, a multiple-lane transportation infrastructure 100 with multiple vehicles 2 that emit particles and stir up suspended particles. Treatment area B thus contains ambient air with a high percentage of solid particles. As a physical part of the enclosure, a roof 20 is provided, which is held on top of a frame or supports, not shown. Although the four sides of treatment area B are open, it is enclosed in these regions by a non-physical element provided by air curtains 52, which are created by fans 53. The fans 53 generate an air flow that is suitable for generating a barrier between treatment area B and the surrounding environment. Also provided are suctioning fans 51, which exert suction on and stabilize the air curtain. The suctioning fans 51 are arranged in the same plane as and opposite the fans 53, so that the air curtains 52 extend substantially straight in the vertical direction.

A number of fans 53 and 51 that matches the size of the treatment area B are arranged along the roadway so as to produce a continuous air curtain 52. In the variant shown, a plurality of air filter devices 10 that are connected in terms of flow to the ambient air of treatment area B are arranged, distributed over the roof 20; these devices suction up and filter solid particles directly from the ambient air of treatment area B, and then return the filtered air to treatment area B or discharge it into the surrounding environment.

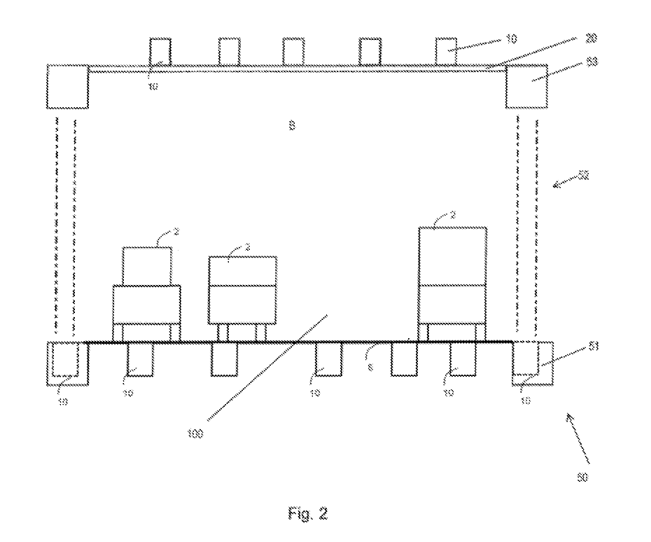

FIG. 2 shows an alternative embodiment example, in which the features that are identical to those of FIG. 1 will not be described again, but are nevertheless part of the embodiment. The surface of the road is formed by an air-permeable grate 5, on and connected to which additional air filter devices 10 are arranged in a shaft, in direct flow connection with the treatment area 10. Air filter devices 10 are also integrated into the suctioning fans 51, for purifying the air flow that is generated in the region of the air curtains 52.

Depending on the required filter performance, it is also conceivable to integrate the air filter devices 10 only into the suctioning fans 51, however this is not specifically shown here.

1. An apparatus for reducing a quantity of solid particles in ambient air, the apparatus comprising:
a predefined treatment area that is delimited at least in part by an enclosure, the enclosure being at least partially non-physical and formed by at least one air curtain that can be produced by an air flow generating device, and
at least one air filter device, which is connected in terms of flow to ambient air of the predefined treatment area and is designed to filter solid particles directly out of the ambient air of the predefined treatment area.

2. The apparatus according to claim 1, wherein some regions of the enclosure are designed as physical.

3. The apparatus according to claim 1, wherein the air flow generating device is at least one fan.

4. The apparatus according to claim 3, wherein the at least one fan is adjustable with respect to its blowing distance and/or blowing pattern.

5. The apparatus according to claim 3, wherein the air generating device is formed by a plurality of fans of the same or different size and/or flow power.

6. The apparatus according to claim 1, wherein the air generating device is formed by a FanWall consisting of a plurality of fans arranged in a row.

7. The apparatus according to claim 1, wherein at least one air intake device is provided, which is designed to exert a suctioning effect on the at least one air curtain.

8. The apparatus according to claim 7, wherein the at least one air intake device is arranged in the same plane as and opposite the air flow generating device, so that air flow generated by the air flow generating device can be suctioned up in the same plane by the air intake device.

9. The apparatus according to claim 1, wherein the at least one air flow generating device comprises an ionization module, and in that ionized air can be discharged by the at least one air flow generating device.

10. The apparatus according to claim 1, wherein the at least one air filter device is located outside of the treatment area.

11. The apparatus according to claim 7, wherein the at least one air filter device is integrated into the at least one air intake device.

12. The apparatus according to claim 1, wherein the at least one air filter device is designed to suction air in from the predefined treatment area, wherein an intake capacity of the at least one air filter device is lower than an output capacity of the air flow generating device.

13. The apparatus according to claim 1, wherein the at least one air filter device is connected to the predefined treatment area in terms of flow via a channel.

14. The apparatus according to claim 1, wherein the enclosure is at least partially formed by at least one air-permeable element.

15. The apparatus according to claim 14, wherein the at least one air-permeable element is a grate that forms a base surface of the predefined treatment area.

16. The apparatus according to claim 15, wherein the at least one air filter device is connected to the predefined treatment area in terms of flow via the grate.

17. The apparatus according to claim 1, wherein the at least one air filter device has a periodically self-cleaning filter.

18. The apparatus according to claim 1, wherein the at least one air filter device has backwash filters.

19. The apparatus according to claim 1, wherein a plurality of air filter devices are provided, arranged spaced from one another along the enclosure.

20. The apparatus according to claim 1, wherein the at least one air filter devices can be positioned in variable locations on the enclosure.
